(19) United States
(12) Patent Application Publication
(10) Pub. No.: US 2013/0157105 A1
(43) Pub. Date: Jun. 20, 2013

(54) AQUEOUS INK FOR THE PRINTING OF ELECTRODES FOR LITHIUM BATTERIES

(71) Applicant: Commissariat A L'Energie Atomique Et Aux Energies Alternatives, Paris (FR)

(72) Inventors: Lionel PICARD, La Tour Du Pin (FR); Nelly GIROUD, Saint Etienne (FR); Hélène ROUAULT, Le Versoud (FR); Sébastien SOLAN, Seyssinet-Pariset (FR)

(73) Assignee: Commissariat A L'Energie Atomique Et Aux Energies Alternatives, Paris (FR)

(21) Appl. No.: 13/770,185

(22) Filed: Feb. 19, 2013

Related U.S. Application Data
(63) Continuation of application No. PCT/FR2011/051777, filed on Jul. 22, 2011.

(30) Foreign Application Priority Data
Sep. 22, 2010 (FR) 10.57593

(51) Int. Cl. H01M 4/62; H01M 4/04

(52) U.S. Cl. CPC H01M 4/624; H01M 4/0402; H01M 4/625
USPC 429/124; 429/211; 427/58; 252/500; 252/519.34; 252/519.33; 252/511

(57) ABSTRACT

It comprises at least one active electrode material and at least one water-soluble or water-dispersible conductive polymer, advantageously PEDOT/PSS.

### FIELD OF THE INVENTION

The present invention relates to an aqueous ink containing an active material and a water-soluble or water-dispersible conductive polymer for the forming of electrodes by printing, especially for secondary lithium batteries.

The field of use of the present invention specifically relates to lithium electrochemical generators operating based on the principle of insertion and desinsertion (or intercalation/deintercalation) of lithium on at least one electrode.

### BACKGROUND OF THE INVENTION

Lithium or Li-ion batteries have a structure comprising two electrodes arranged on either side of an organic or inorganic separator. These two electrodes, one positive and the other negative, are both assembled on a metal current collector.

In the case of printed Li-ion batteries (FIG. 1), the different battery elements are successively printed according to the steps of:
depositing a first electrode (positive or negative) on a first metal current collector;
depositing the polymer or ceramic separator on the first electrode;
depositing the second electrode (positive or negative, opposite to the first electrode) on the separator;
installing the second current collector.

Printed batteries have the advantage of being flexible with a cohesive structure (the different layers cannot move with respect to one another) and of being light. The printing of electrodes may especially be performed by screen printing (FIG. 2), flexography (FIG. 3), rotogravure (FIG. 4), or by ink jet. Such printing techniques generally allow high production rates.

Typically, electrode inks contain an active electrode material, one or several carbon electronic conductor(s), one or several binder(s), and an organic solvent.

The electrochemically-active material allows the insertion and the desinsertion of lithium cations while the electronic conductor enables to improve electric conduction. On the other hand, the binder not only eases the bonding of the ink composition to the current collector, but also improves the cohesion of the active material.

The aqueous forming of certain active materials such as carbon, LiFePO₄ (lithium iron phosphate), or Li₄Ti₅O₁₂ (lithium titanium oxide) generally requires using water-soluble polymers such as cellulose derivatives CMC (carboxymethylcellulose), HMC (hydroxymethylcellulose), associated with latex copolymers such as NBr (acrylonitrilbutadiene), SBr (styrene-butadiene), or the ethylene-propylene-diene terpolymer. Although inks formulated with such polymer mixtures have a good electrode flexography printing quality, batteries comprising such electrodes do not have as high an electrochemical performance as batteries provided with organically formulated electrodes.

The physicochemical characteristics of the polymer binders used have an influence on the surface tension and on the rheological character of inks. The optimal pattern definition and the area capacity of the electrode thus result from the choice of the binder, of the active material, and of the dry extract, especially in screen printing. Further, in flexography, the optimization of the different ink transfers and the quality of the resulting electrodes depend on the surface tension adjustment.

PVDF (polyvinylidene fluoride) is one of the most widely used binders in Li-ion battery electrodes. However, it generally induces very low ink surface tension values, thus making flexography printing very difficult. The introduction of a second highly-polar polymer such as PVA (poly(vinylalcohol)) enables to increase the surface tension and thus to print by flexography. However, this addition causes problems of short-term ink stability.

Electronically conductive polymers may be used to replace or in addition to conventional electronic conductors (carbon black, carbon fibers, . . . ). For example, polyaniline, polypyrroles, and polythiophenes, and more specifically PEDOT (poly(3,4-ethylenedioxythiophene)) often associated with PSS (poly(styrenesulfonate)) are mainly used for their user-friendliness as compared with conductive particle suspensions, but also for the possibility of improving the electrical percolation of active electrode materials.

Document WO2004/011901 describes an electrode obtained by coating with an ink especially comprising particles of active material (LiFePO₄) covered with a layer of conductive material (PEDOT-PSS) and with a material having a low refraction index (fluorinated polymers, vanadium oxide, polypropylene).

Document US2009/0095942 describes the cathode of a secondary lithium battery containing an electrically-conductive polymer having an amino group, a hydrogen bond compound, and a protonic acid. This electrode is manufactured by aqueous coating.

Document U.S. Pat. No. 7,651,647 describes the manufacturing of cathodes for primary lithium battery electrochemical cells (non-rechargeable batteries). An active cathode material (oxide of vanadium - silver or fluorinated carbon) and a conductive polymer (polyaniline and/or polydioxythiophene) are first mixed without adding other binders than the conductive polymer. The mixture is then elaborated to form the cathode(a) either by sintering of the powder on the current collector, whereon the conductive polymer may be previously deposited, (b) or by sintering of the powder in the form of a sheet, which is then deposited on the current collector, accordingly creating the contact.

As already indicated, techniques for printing Li-ion battery electrodes may have limitations. Indeed, in flexography, the surface capacities obtained in a single go are low. Further, the pressures used for the different transfers with inks formulated with electronically-conductive polymers are low (from 10 to 50 N) and strongly depend on the hardness of the polymer of the printing plate.

The area capacity is also strongly dependent on the anilox roll loading capacity, that is, on the shape and on the depth of the patterns present thereon. In the best conditions of transfer, of surface energy differences between the ink and the different rolls, the quantity of transferred ink is at best one quarter of the quantity of ink present on the anilox roll.

In the case of rotogravure, the quantity of transferred ink typically is at best half the quantity of ink present on the roll.

Although prior art has inks for the printing of Li-ion battery electrodes, the latter are not satisfactory. Indeed, the active material is often associated with an additional polymer to ease its forming. Further, certain binders such as PVDF require adding a highly polar polymer (PVA) to reach a surface tension adapted to printing techniques. This last solution remains unsatisfactory, the PVDF/PVA mixture being unstable.

The present invention relates to a stable aqueous ink, having a viscosity which enables to improve the printing of electrodes of Li-ion batteries by flexography, rotogravure, or screen printing.

### SUMMARY OF THE INVENTION

The Applicant has developed an aqueous ink for the printing of electrodes, with a formulation comprising an electronically-conductive polymer binder further enabling to increase the surface tension of said ink. This ink enables to improve the different transfers during the printing process, as well as the bonding of the electrode to the current collector.

More specifically, the present invention relates to an aqueous ink for the forming of electrodes by printing, comprising at least one active electrode material and at least one water-soluble or water-dispersible conductive polymer. This polymer is formed at least of the PEDOT/PET association and has a viscosity ranging between 20 and 100 dPa·s.

As already indicated, PEDOT is a poly(3,4-ethylenedioxythiophene) polymer while PSS is a polystyrene sulfonate. The viscosity of the PEDOT/PSS association varies according to the very nature of these polymers.

The active electrode material of the aqueous ink according to the invention may advantageously be selected from the group comprising the following compounds: LiFePO₄, LiCoO₂, Li₄Ti₅O₁₂, Cgr, Si, SiC, LiNiₓCo_{y}Al_{z}O₂ with x+y+z=1. As already indicated, the active material enables to insert and desinsert lithium cations.

More advantageously still, the active material of a positive electrode is LiFePO₄, while LiTi₅O₁₂ is preferred in the case of a negative electrode.

Unlike prior art, the aqueous ink according to the present invention does not necessarily comprise conventional carbon electronic conductors, given that electronically-conductive polymers play the double role of binder and of electronic conductor. The proportion of active material in the ink can thus be significantly increased. Further, in the ink according to the invention, the active material is not associated with PVDF (polyvinylidene fluoride) which decreases the surface tension. According to a preferred embodiment, the aqueous ink according to the present invention comprises a single electronic conductor, PEDOT/PSS.

According to a preferred embodiment, the quantity of active electrode material ranges between 25 and 50% of the weight of the aqueous ink according to the present invention, and more advantageously still between 40 and 50%.

The aqueous ink according to the invention further comprises at least one water-soluble conductive polymer, which also fulfils a binding function. It advantageously is the PEDOT/PSS association. According to a preferred embodiment, the aqueous ink according to the present invention comprises a single water-soluble conductive polymer, PEDOT/PSS.

PEDOT/PSS is poly(3,4-ethylenedioxythiophene) (PEDOT) associated with polystyrene sulfonate (PSS) to dope its conductivity. The PEDOT/PSS ratio advantageously ranges between 1/2.5 and 1/1.

Advantageously, the present invention enables to formulate all the active materials currently used in the field of aqueous Li-ion batteries by using, as an electronically conductive binder, a viscous aqueous dispersion of PEDOT/PSS.

The quantity of water-soluble or water-dispersible conductive polymer advantageously ranges between 1.5 and 4% with respect to the weight of the aqueous ink, and more advantageously still between 1.5 and 2.5%.

As already specified, the PEDOT/PSS used in the context of the present invention is a mixture of polymers having a viscosity ranging between 20 and 100 dPa·s. Its viscosity advantageously is on the order of 60 dPa·s. Unlike prior art inks comprising PEDOT/PSS, the aqueous ink according to the invention may be used by printing, due to the viscosity of PEDOT/PSS.

Advantageously, the viscosity of the aqueous ink according to the invention ranges between 0.1 Pa·s and 25 Pa·s submitted to a 12 s⁻¹ shearing speed and more advantageously still between 0.5 and 15 Pa·s.

It will be within the abilities of those skilled in the art to adjust the proportions of the aqueous ink components to obtain the desired viscosity, the desired rheological behavior varying according to printing techniques. Indeed, while flexography and rotogravure require inks having a liquid shear rate thinning character and having a relatively long relaxation time, it is preferable to use more viscous inks with a shear rate thinning character and having a shorter relaxation time for screen printing.

According to a specific embodiment of the invention, the aqueous ink may further comprise at least one additive selected from among electronic conductors such as

Super P® carbon, carbon fibers.

According to another specific embodiment, the aqueous ink according to the present invention consists of at least one active electrode material and PEDOT/PSS, the viscosity of PEDOT/PSS advantageously ranging between 20 and 100 dPa·s.

The present invention also relates to the use of said aqueous ink to form an electrode by printing of said aqueous ink on a current collector. Said electrode may be positive or negative.

The method for forming said electrode comprises the steps of:
depositing the aqueous ink according to the present invention on a current collector, said deposition being advantageously performed by inkjet printing, flexography, rotogravure, or by screen printing;
drying the ink;
possibly compressing or calendering the electrode formed by deposition of the ink on the current collector.
   The ink deposition may possibly be performed by coating.

Advantageously, the current collector may be made of aluminum, copper, or nickel, or even alloys of these metals. According to a preferred embodiment, the current collector of the positive electrode is made of aluminum while that of the negative electrode is made of copper.

The present invention also relates to an electrode capable of being obtained according to the above-described manufacturing method.

The dry extract of the aqueous ink according to the invention typically ranges between 30 and 60%. It represents the percentage of solid matter with respect to the ink components as a whole.

As already indicated, the proportion of active material in the aqueous ink according to the invention may be significantly increased, thus enabling to obtain an electrode having a higher capacity per weight and per volume than in prior art.

Advantageously, the area capacity of the electrode according to the invention is greater than 3 mAh.cm⁻² for a charge-discharge rate greater than 2 C, that is, a charge (or discharge) time of 30 minutes at 6 mA for a battery with electrodes having a 1-cm² surface area.

The invention also concerns a lithium accumulator comprising at least one electrode prepared by deposition of the ink according to the invention, but also a lithium battery comprising at least one lithium accumulator according to the invention.

Advantageously, the lithium battery is a secondary lithium battery in which the electrodes are typically separated by an organic or inorganic separator.

The electrodes resulting from the present invention may give rise to three types of batteries where a lithium ion exchange occurs between the positive electrode and the negative electrode:
energy sources enabling to provide low currents for a very long type, generally with high capacities per weight and volume;
power sources enabling to provide high currents for a rather short time, generally with lower capacities per weight and volume;
high-capacity power sources, enabling to provide high currents (if not, low currents) for a long time, generally with high capacities per weight and volume.

The invention and the resulting advantages will better appear from the following drawings and examples.

### BRIEF DESCRIPTION OF THE DRAWINGS

FIG. 1A illustrates the schematized principle of the design of a printed lithium-ion battery.

FIG. 1B illustrates an assembled battery, in top view and in side view.

FIG. 2 illustrates the principle of screen printing of electrodes and membranes for Li-ion batteries.

FIG. 3 illustrates the principle of flexography printing of electrodes and membranes for Li-ion batteries.

FIG. 4 illustrates the principle of rotogravure printing of electrodes and membranes for Li-ion batteries.

FIG. 5 shows the results of cycling test at different rates providing the performance of LiFePO₄/PEDOT-PSS electrodes according to the invention as compared with a LiFePO₄ electrode according to prior art.

FIG. 6 shows the results of cycling tests at different rates providing the performance of a LiCoO₂ /PEDOT-PSS electrode according to the invention.

FIG. 7 shows the results of cycling tests at different rates providing the performance of a Li₄Ti₅O₁₂ /PEDOT-PSS electrode according to the invention.

FIG. 8a shows a board of electrodes printed by flexography of an ink having a 45% dry extract of the invention. FIG. 8b shows an enlarged view of a pattern, thus high-lighting the fine definition of the electrodes.

FIG. 9 shows a board of electrodes printed by flexography of an ink having a 40% dry extract.

FIG. 10 shows a board of electrodes printed by flexography of an ink with a printing plate comprising more patterns than the board illustrated in FIG. 8. It enables to highlight the lack of inking between electrodes due to the greater closeness of the patterns on the printing plate.

### DETAILED DESCRIPTION OF THE DRAWINGS

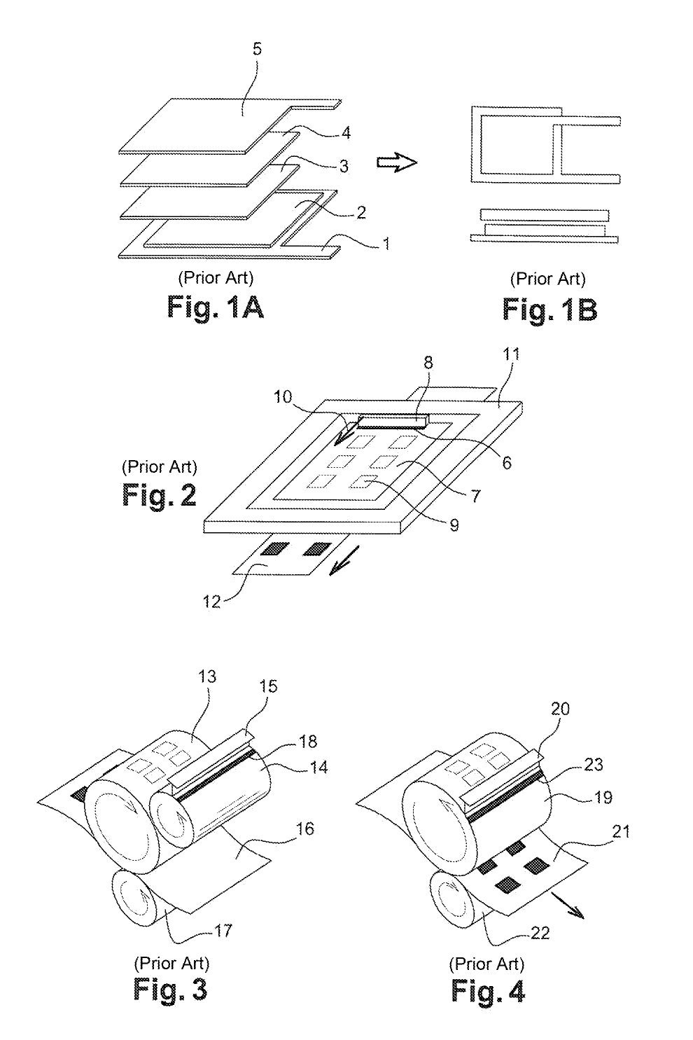

FIG. 1A illustrates the schematized principle of the design of a printed lithium-ion battery. A first electrode (2) is printed on the first current collector (1). The separator (3) is then printed on the first electrode (2). It enables to avoid any short-circuit between the two electrodes. The second electrode (4), having a charge opposite to that of the first electrode (2), is printed on the separator (3) before being covered with the second current collector (5).

FIG. 2 illustrates the principle of screen printing of electrodes and membranes for Li-ion batteries. An ink cord (6) is directly deposited on the mask (7) itself supported by a frame (11). The ink cord (6) is then pushed by the doctor blade (8) according to a settable speed (10). The pressure applied to the doctor blade is also adjustable. It enables to adjust the setting of the area capacity in the case where the patterns (9) are stencils and enables the passing of ink (6) through the meshes in the case where the patterns (9) are meshed. The area capacity is set in the case of screen printing by the thickness of the mask (7) and by the dimension and the shape of the mesh if the printing patterns (9) are meshed. This printing technique is reel-to-reel rather than roll-to-roll. It is carried out on a printing support (12).

FIG. 3 illustrates the principle of flexography printing. The patterns on the printing plate (13) are raised. The ink is directly placed on the anilox roll (14), in an ink tank or in an inking head. The anilox roll is thus inked by rotation (ink cord (18)) and a doctor blade (15) is positioned either positively, or negatively with respect to the rotation axis of the anilox roll to remove the excess ink. The anilox roll then comes into contact with the printing plate and inks the raised portions of the printing roll (the pattern) by ink transfer. The printing roll then comes into contact with the printing support (16) which, in the present case, is the current collector. A counter-pressure cylinder (17) comes into contact with the printing support (16) to control the pressure applied on transfer of the ink from the inking roll to the printing support (16). The different pressures (anilox roll/printing plate inking pressure and printing plate/printing support printing pressure) are settable and enable to adjust the deposition thickness, which, in the case of the printing of Li-ion batteries, enables to set the final electrode area capacity, and the spatial definition of the printing pattern.

FIG. 4 illustrates the principle of rotogravure printing of electrodes and membranes for Li-ion batteries. The engraved metal cylinder (19) of the printing plate is directly inked (23) in an inking tank or in an inking head. As in the case of flexography, the cylinder is equipped with a doctor blade system (20) to remove the excess ink from the roll. The engraving depth of the cylinder (19) enables to set the wet height of the deposition and accordingly the area capacity of the electrode. The inked cylinder then comes into contact with the printing support (21) which, in the case of Li-ion batteries, is the current collector.

By rotation and ink transfer, the electrode is printed. The printing pressure between the inked cylinder and the support is provided by a counter-pressure cylinder (22) and is settable. The pressure is in this case also relatively low to obtain the largest possible area capacities and is strongly dependent on the hardness of the polymer used to cover the counter-pressure cylinder. Just as for flexography, it is on the order of from 10 to 50 N. The area capacity will be dependent on the depth of the engraved pattern. In the best conditions of transfer, of surface energy differences between the ink and the different rolls, the quantity of transferred ink is at best one half the quantity of ink present on the cylinder.

### Embodiments of the Invention

Examples 1 to 5 relate to an aqueous ink according to the present invention and to its use to manufacture electrodes, while comparative example 1 relates to a prior art ink. Examples 6 to 8 illustrate the printing of electrodes by flexography of the ink according to the present invention.

### EXAMPLE 1

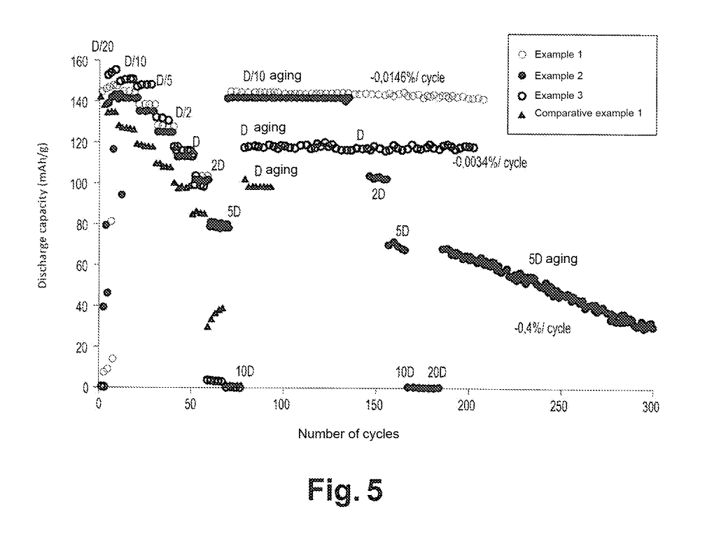

This example is illustrated in FIG. 5.

### Materials:

In this example, the active material used is carbon containing LiFePO₄ from Pulead Technology Industry. The electronically-conductive polymer used is a viscous grade of a PEDOT-PSS dispersion in water with additional binders from H.C.Starck Clevios GmbH and sold under trade name Clevios S V3 (resistivity of a printed film: approx. 700 Ω/sq, viscosity at ambient temperature: 60 dPa·s, measured dry extract: 6.5%).

The polyethylene used to separate the two electrodes of the button cell corresponds to grade Celgard 2400.

### Forming of the Electrode and of the Button Cell:

A positive electrode is obtained by mixing 93.6 parts by weight of Pulead LiFePO₄ and 6.4 parts by weight of PEDOT-PSS. Pure water, that is, deionized water, is then added to the mixture to obtain a dry extract of 45.1% by weight.

The ink is then mixed by means of a kinetic blade mixer at a 2,000 rpm for 30 min. An ink having a viscosity adapted to a forming technique such as screen printing or coating, that is, from 6 Pa·s to 12 Pa·s is obtained.

The ink is then spread on an aluminum current collector at a 150-μm thickness, and then dried at 50° C. for one day. This 150-μm height enables to obtain an electrode with an area capacity of 1.16 mAh.cm⁻².

A pellet having a 14-mm diameter is than sampled from this electrode, after which it is compressed under a 2-ton pressure (1.3 T.cm⁻²) by means of a press. This pellet is then dried at 100° C. for 48 h under vacuum in a Büchi-type system to remove possible residual traces of water, before being introduced in a glove box. It is then assembled as a button cell opposite to a metal lithium electrode having a 16-mm diameter with, as a polymer separator, a 16.5-mm-diameter pellet of a polyethylene separator.

### Button Cell Charge-Discharge Tests and Results:

The button cell then undergoes different charge-discharge cycles at different rates between 2 V and 4.2 V: 10 C/20-D/20 cycles; 10 C/10-D/10 cycles; 10 C/5-D/5 cycles; 10 C/5-D/2 cycles; 10 C/5-D cycles; 10 C/5-2D cycles; 10 C/5-5D cycles; then, a C/10-D/10 cycling aging over more than 100 cycles.

The discharge capacity results at the different rates are discussed in FIG. 5 and show a recovered capacity of 148 mAh.g⁻¹ at D/20 and of 78 mAh.g⁻¹ at 5D.

The D/10 aging shows a capacity loss of 2% after 137 cycles (−0.0146%/cycle) with a recovered capacity on the order of 144 mAh.g⁻¹. Such results are excellent in light of the results obtained in comparative example 1.

A C/20 charge means that a constant current is imposed to the battery for 20 hours, the value of the current being equal to the capacity divided by 20. A 2 C cycle corresponds to a 30 minute charge while a C-D/5 cycle corresponds to a one hour charge and a 5 hour discharge.

### EXAMPLE 2 (FIG. 5)

in this example, the formulation used and the manufacturing conditions of the electrode and of the button cell are identical to those described in example 1, with the sole difference that the compression applied to the electrode is of 1 ton (that is, 0.65 T/cm²).

The button cell undergoes the same sequence of cycles as that used for example 1, with the difference that after 66 C/10-D/10 aging cycles, a new series of cycles at different rates is applied to the button cell: 10 C/5-D cycles; 10 C/5-2D cycles; 10 C/5-5D cycles; 10 C/5-10D cycles; 10 C/5-20D cycles; then, a C/5-5D cycling aging over more than 100 cycles.

The discharge capacity results at the different rates are discussed in FIG. 5 and show a recovered capacity of 141 mAh.g⁻¹ at D/20 and of 78 mAh.g⁻¹ at 5D.

The D/10 aging reveals no capacity loss after 65 cycles with a recovered capacity on the order of 142 mAh.g⁻¹.

The new series of cycles at different rates performed afterwards provides results identical to those found for the first series. The 5D aging provides a capacity loss of −0.4% /cycle (−54% of the initial capacity at 5D over 115 cycles).

These results are excellent in light of the results obtained in comparative example 1 and similar to those obtained in example 1.

### EXAMPLE 3 (FIG. 5)

The embodiments of the electrode and of the button cell are identical to those described in example 1, according to the parameters of table 1.

The button cell then undergoes different charge-discharge cycles at different rates between 2 V and 4.2 V. 5 C/20-D/20 cycles; 5 C/10-D/10 cycles; 5 C/5-D/5 cycles; 5 C/5-D/2 cycles; 5 C/5-D cycles; 5 C/5-2D cycles; 5 C/5-5D cycles; 5 C/5-10D cycles; then, a C/5-D cycling aging.

The discharge capacity results at the different rates are discussed in FIG. 5 and show a recovered capacity of 155 mAh.g⁻¹ at D/20, and of 99 mAh.g⁻¹ at 2D, but smaller than 5 mAh.g⁻¹ at 5D. The D aging reveals a capacity loss smaller than 0.5% after 62 cycles (−0.0034% /cycle) with a recovered capacity on the order of 118 mAh.g⁻¹.

These results are excellent in light of the results obtained in comparative example 1 and similar to those obtained in example 1 and in example 2. The stronger capacity recovered at low rate originates from the electrode area capacity difference. These results also show that a compression of the pellet, even light, seems necessary for a proper operation at high rates.

### COMPARATIVE EXAMPLE 1 (FIG. 5)

The embodiments of the electrode and of the button cell are identical to those described in example 1, according to the parameters of table 1 hereinafter.

An ink having a viscosity ranging from 6 Pa·s to 12 Pa·s is obtained by mixing:
82 parts by weight of Pulead LiFePO₄,
4 parts by weight of Super P carbon,
6 parts by weight of VGCF carbon fibers (“Vapor Generated Carbon Fibers”); and
8 parts by weight of polyvinylidene fluoride PVDF (Solvay grade SOLEF®6020) solubilized at 12% by weight in N-methylpyrrolidinone NMP.
   Pure NMP is then added to the mixture to obtain a dry extract of 41.4% by weight.

The button cell then undergoes different charge-discharge cycles at different rates between 2 V and 4.2 V. 5 C/20-D/20 cycles; 5 C/10-D/10 cycles; 5 C/5-D/5 cycles; 5 C/5-D/2 cycles; 5 C/5-D cycles; 5 C/5-2D cycles; 5 C/5-5D cycles; 5 C/5-10D cycles; then, a C/5-D cycling aging.

The discharge capacity results at the different rates are discussed in FIG. 5 and show a recovered capacity of 135 mAh.g⁻¹ at D/20, of 85 mAh.g⁻¹ at 2D, and on the order of 40 mAh.g⁻¹ at 5D.

The D aging reveals a good stability with a recovered capacity on the order of 98 mAh.g⁻¹. These results reveal that the results obtained with the electrodes obtained according to examples 1, 2, and 3 are excellent.

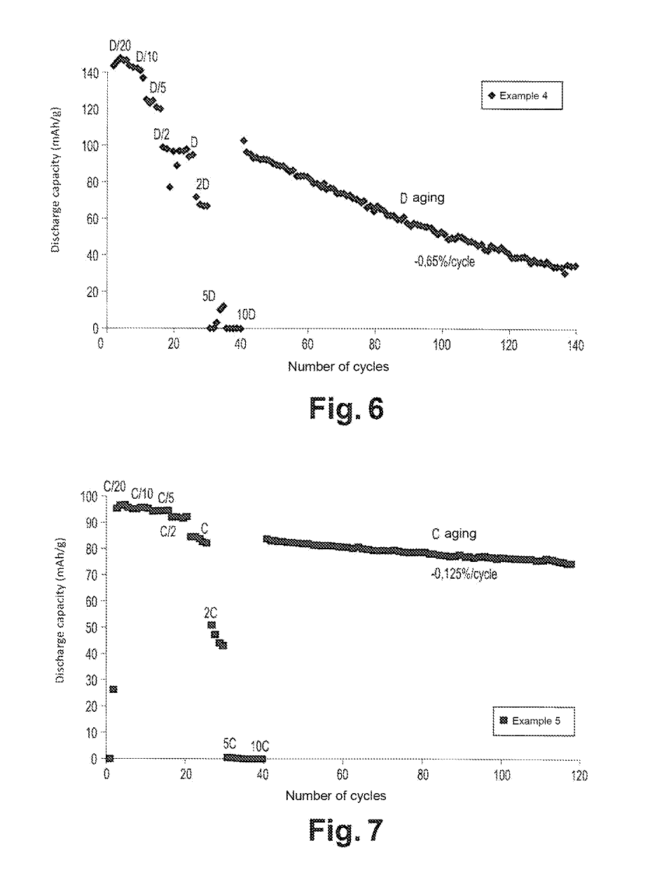

### EXAMPLE 4 (FIG. 6)

The embodiments of the electrode and of the button cell are identical to those described in example 1, according to the parameters of table I.

The button cell then undergoes different charge-discharge cycles at different rates between 2.5 V and 4.25 V. 5 C/20-D/20 cycles; 5 C/10-D/10 cycles; 5 C/5-D/5 cycles; 5 C/5-D/2 cycles; 5 C/5-D cycles; 5 C/5-2D cycles; 5 C/5-5D cycles; 5 C/5-10D cycles; then, a C/5-D cycling aging.

The discharge capacity results at the different rates are discussed in FIG. 6 and show a recovered capacity of 147 mAh.g⁻¹ at D/20 and of 67 mAh.g⁻¹ at 2D, but smaller than 12 mAh.g⁻¹ at 5D.

The D aging reveals a 70% capacity loss after 100 cycles (−0.6% /cycle). These results show that the aqueous forming of this material is possible with PEDOT/PSS as a binder and that it is possible to recover the entire discharge capacity at low rate.

### EXAMPLE 5 (FIG. 7)

The embodiments of the electrode and of the button cell are identical to those described in example 1, according to the parameters of table I.

The button cell then undergoes different charge-discharge cycles at different rates between 1 V and 2.8 V. 5 C/20-D/20 cycles; 5 C/10-D/10 cycles; 5 C/5-D/5 cycles; 5 C/2-D/5 cycles; 5 C-D/5 cycles; 5 2 C-D/5 cycles; 5 5 C-D/5 cycles; 5 10 C-D/5 cycles; then, a C-D/5 cycling aging.

The charge capacity results at the different rates are discussed in FIG. 7 and show a recovered capacity of 96 mAh.g⁻¹ at C/20 and of 45 mAh.g⁻¹ at 2 C, but smaller than 1 mAh.g⁻¹ at 5 C.

The C aging reveals a 11% capacity loss after 77 cycles (−0.125%/cycle). These results prove that the use of PEDOT/PSS for negative electrodes is possible. The capacity recovered at low rate is not complete and this phenomenon may be due to the excessive compression applied on the electrode.

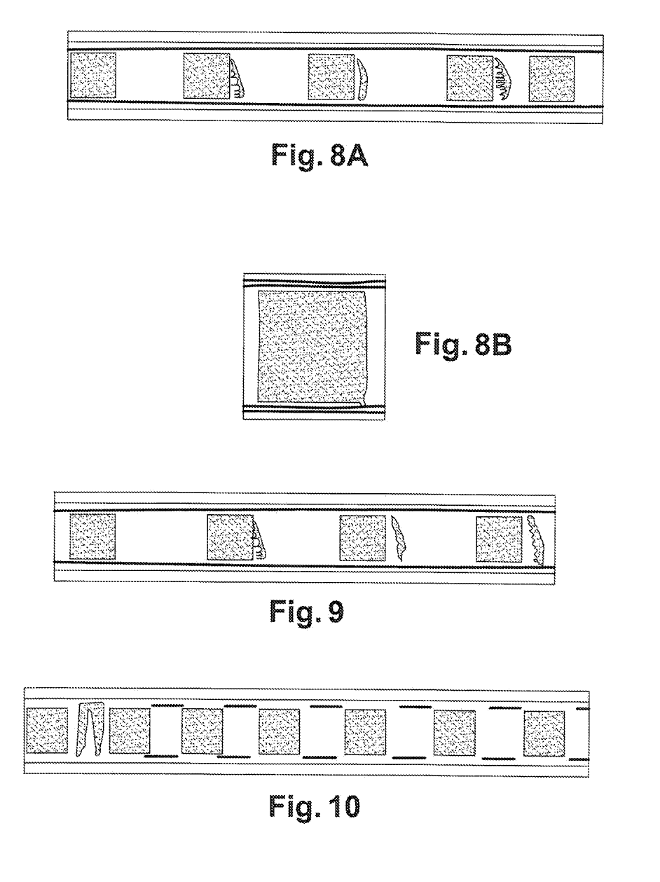

### EXAMPLE 6 (FIG. 8)

This example proves the possibility of printing by Ilexography inks formulated with the PEDOT-PSS used in examples 1 to 5.

An ink is obtained according to the method disclosed in examples 1 and 2 with a 45% dry extract. 5 ml of this ink is deposited on the surface of an anilox roll having a 100 cm³ capacity with a 45° striate pattern. The doctor blade, positively mounted, then dispenses the ink over the entire surface of anilox roll. The anilox roll then comes into contact with the printer form, having a photocurable polymer as a surface material.

The raised patterns are then inked by applying a 10-N pressure between the anilox roll and the printing plate.

The printing plate then comes into contact with the printing support (aluminum strip having a 20-μm thickness). The pressure exerted between the counter-pressure cylinder and the printing plate (the Al support is between the two) is 20 N.

The ink then very correctly transfers, with a few fins however appearing between patterns. These are probably due to too much ink on the anilox roll, which has accordingly inked between the raised patterns.

With this 100-cm³ anilox roll, in the best transfer conditions, the thickness of the wet deposition must theoretically reach 25 μm, which, with a 45% dry extract, theoretically provides a final electrode thickness of approximately 12 μm.

The formed electrodes have in average a 11.5-μm thickness (FIGS. 8a and 8b), which indicates a 98% transfer rate. The aqueous LiFePO₄ and PEDOT-PSS formulation thus has a surface energy perfectly adapted for the different flexography transfers.

### EXAMPLE 7 (FIG. 9)

An ink similar to that of example 6 but with a 40% dry extract provides electrodes having an average thickness after drying of 9.7 μm, corresponding to an ink transfer rate of 97% with respect to theory.

### EXAMPLE 8 (FIG. 10)

The ink used in this example is perfectly identical to that of example 6. A modification has been made to the printing plate: the patterns are closer, which enable to limit the phenomenon observed in examples 6 and 7 of inking between patterns, but the material is the same. The spatial definition of the electrodes is thus considerably improved. The transfer rate is of a quality comparable to that of example 6.

TABLE 1
Ink composition and electrode area capacity.

| | Example | | | | | | Comparative | | | | |
|---|---|---|---|---|---|---|---|---|---|---|---|
| | 1 | | 2 | | 3 | | example 1 | | 4 | | 5 |
| Electrode | positive | | positive | | positive | | positive | | positive | | negative |
| type | | | | | | | | | | | |
| Ink | LiFePO₄ | | LiFePO₄ | | LiFePO₄ | | LiFePO₄ | | LiCoO₂ | | Li₄Ti₅O₁₂ |
| composition | (93.6) | | (93.6) | | (90) | | (82) | | (95)^{(a)} | | (95)^{(b)} |
| | | | | | | | VGCF (6) | | | | |
| | | | | | | | PVDF (8) | | | | |
| | PEDOT- | | PEDOT- | | PEDOT- | | C super P (4) | | PEDOT- | | PEDOT- |
| | PSS | | PSS | | PSS (10) | | | | PSS (5) | | PSS (5) |
| | (6.4) | | (6.4) | | | | | | | | |
| Solvent | water | | water | | water | | NMP | | water | | water |
| Dry extract | 45.1 | | 45.1 | | 30.7 | | 41.4 | | 52 | | 52 |
| (% by | | | | | | | | | | | |
| weight) | | | | | | | | | | | |
| Ink mixing | 2,000 | rpm | 2,000 | rpm | 800 | rpm | 800 | rpm | 800 | rpm | manual |
| | 30 | min | 30 | min | 15 | min | 10 | min | 10 | min | |

| | | | | | | |
|---|---|---|---|---|---|---|
| Area | 1.16 | 1.16 | 0.38 | 0.89 | 1.3 | 1.87 |
| capacity | | | | | | |
| (mAh · cm⁻²) | | | | | | |
| Pressure | 2 | 1 | — | — | — | 15 |
| (T) | | | | | | |

^{(a)}LiCoO₂ from Itochu Corporation (grade 8 G with an average particle diameter of 30 μm)
^{(b)}Li₄Ti₅O₁₂ from Altaïr-Nano

1. An aqueous ink for the forming of electrodes by printing, comprising at least one active electrode material and at least one water-soluble or water-dispersible conductive polymer, said polymer being made at least of the PEDOT/PSS association having a viscosity ranging between 20 and 100 dPa·s.

2. The aqueous ink of claim 1, wherein the active electrode material is selected from the group comprising LiFePO₄, CoO₂, Li₄Ti₅O₁₂, Cgr, Si, SiC, LiNiₓCo_{y}Al₂O₂ with x+y+z=1.

3. The aqueous ink of claim 1, wherein the viscosity of the water-soluble or water-dispersible conductive polymer is on the order of 60 dPa·s.

4. The aqueous ink of of claim 1, wherein the viscosity of the aqueous ink ranges between 0.1 Pa·s and 25 Pa·s, and more advantageously still between 0.5 and 15 Pa·s.

5. The aqueous ink of of claim 1, wherein the quantity of active electrode material ranges between 25 and 50% with respect to the weight of the aqueous ink, more advantageously between 40 and 50%.

6. The aqueous ink of claim 1, wherein the quantity of water-soluble or water-dispersible conductive polymer ranges between 1.5 and 4% with respect to the weight of the aqueous ink, more advantageously between 1.5 and 2.5%.

7. The aqueous ink of claim 1, wherein the aqueous ink further comprises at least one additive selected from the group comprising: electronic conductors such as carbon fibers.

8. A use of the aqueous ink of claim 1 for the forming of a positive or negative electrode, by printing of said aqueous ink on a current collector.

9. A method for manufacturing an electrode comprising the steps of:
depositing the aqueous ink of claim 1 on a current collector, said deposition being advantageously performed by inkjet printing, flexography, rotogravure, or by screen printing;
drying the ink.

10. A method for forming the electrode of claim 9, further comprising a step of compressing or calendering the electrode formed by deposition of the ink on the current collector.

11. An electrode obtained according to claim 9.

12. The electrode of claim 11, wherein its area capacity is greater than 3 mAh.cm⁻² for a charge-discharge rate greater than 2 C.

13. A lithium accumulator comprising at least one electrode of claim 11.

14. A lithium battery comprising at least one accumulator of claim 13.
